(19) United States
(12) Patent Application Publication
(10) Pub. No.: US 2008/0041982 A1
(43) Pub. Date: Feb. 21, 2008

(54) CONSTRUCTION AND DEMOLITION WASTE RECYCLING SYSTEM AND METHOD

(75) Inventors: JONATHAN C. PAULSON, West Des Moines, IA (US); KURT A. PAGLIAI, Des Moines, IA (US)

Correspondence Address: MCKEE, VOORHEES & SEASE, P.L.C., 801 GRAND AVENUE, SUITE 3200, DES MOINES, IA, 50309-2721, US

(73) Assignee: ENVIRONMENTAL RECLAMATION AND RECYCLING, L.C., West Des Moines, IA (US)

(21) Appl. No.: 11/461,230

(22) Filed: Jul. 31, 2006

(51) Int. Cl. B02C 17/02

(52) U.S. Cl. 241/24.19

(57) ABSTRACT

The present invention is a system and method for creating a coal replacement wood waste fuel produced from waste construction and demolition refuse. Construction demolition refuse is gathered and separated into recyclable items and non-recyclable items. Then, larger recyclable items are conveyed to a picking room and smaller recyclable items are screened to remove dirt and gravel. The larger of the smaller particles are then re-united with the larger recyclable materials. Non-fuel products are picked off a conveying system and discarded or recycled otherwise. The fuel products remaining on the conveying system are ground into a coal replacement wood waste fuel. Wet or dry fuel supplements may be added to the wood waste fuel. Additionally, the fuel may be gasified to create a burnable gas.

### BACKGROUND OF THE INVENTION

The present invention relates to a construction and demolition waste recycling system and method. Specifically, the present invention relates to creating a coal replacement wood waste fuel product produced from waste construction and demolition refuse.

It is well-known in the art that construction and demolition produces a large amount of scraps or waste material. For years, this scrap or waste refuse material has been thrown into landfills to decay. Since construction is an ongoing process, a very large amount of this construction and demolition refuse is filling up landfills.

Many industrial facilities, such as power plants, burn coal and gas to power their facilities and/or generate electricity. This process is getting increasingly expensive with the high costs of energy. In addition, coal is becoming disfavored for its pollutant effect on the environment.

In light of the foregoing, it is desirable to both reduce construction and demolition waste refuse and to provide alternative energy sources for industry. As a result, the primary feature or advantage of the present invention is to provide an improved construction and demolition waste recycling system and method.

A further feature or advantage of the present invention is to provide a system for recycling bulk construction and demolition waste refuse into a renewable energy source.

Another feature or advantage of the present invention is to provide a method for efficiently converting construction and demolition waste refuse into a renewable energy source.

A further feature or advantage of the present invention is a provision of a construction and demolition waste recycling system and method which is economical to manufacture, durable in use, and efficient in operation.

One or more of these and/or other features or advantages of the present invention will be apparent from the specification and claims that follow.

### BRIEF SUMMARY OF THE INVENTION

One or more of the foregoing features or advantages may be achieved by a system for creating a coal replacement wood waste fuel produced from waste refuse having a tipping floor for gathering bulk refuse, a loading device for separating the refuse into recyclable items and non-recyclable items and for loading the recyclable items which are to be screened, a screen for separating the recyclable items into large recyclable items and small recyclable items, a conveyor for transporting the large recyclable items to be separated as fuel products and non-fuel products, a picking area for separating the non-fuel products off the conveyor and away from the fuel products and discarding the non-fuel products, a grinder for grinding the fuel products into a wood waste fuel and a magnet and/or eddy current separator for removing metals from the wood waste fuel.

A further feature or advantage of the present invention is the capability of adding wet fuels to the wood waste fuel for increasing BTU value of the fuel.

A further feature or advantage of the present invention is that the wood waste fuel may be at least partially consumed in a gasifier to output a burnable gas.

A further feature or advantage of the present invention is that the wood waste fuel may have a moisture content of about 10% to 20% and a BTU value of about 6,000 to 8,000.

A further feature or advantage of the present invention allows non-fuel items which are separated from the recyclable fuel items to be stored and recycled separately.

One or more of the foregoing features or advantages may additionally be achieved by a method of creating a coal replacement wood waste fuel produced from waste refuse by compiling bulk refuse, separating the bulk refuse into recyclable refuse and non-recyclable refuse, separating dirt away from the recyclable refuse, conveying the recyclable refuse to a picking area, determining what of the recyclable refuse is fuel products and what is non-fuel products, picking the non-fuel products from the conveyed fuel products, grinding the fuel products into a wood waste fuel, and removing metals from the ground fuel products.

A further feature or advantage of the present invention is that the wood waste fuel may be ground any number of times to create the desired particle size and mixture homogeniality.

One or more of the foregoing features or advantages may additionally be achieved by a construction and demolition waste recycling system for converting high BTU value construction demolition waste refuse into a coal replacement wood waste fuel having about a 6,000 to 8,000 BTU value, the system having an area for gathering both construction demolition refuse materials, a loading device for crushing oversized refuse materials and for moving the gathered refuse materials, a vibrating screening system for receiving the refuse materials and separating dirt from the refuse materials, a picking system for removing non-fuel products from the refuse materials, a grinder for grinding remaining refuse materials into a wood waste fuel, and a metal removing system for removing metal from the wood waste fuel.

A further feature or advantage of the present invention allows for concrete, brick, and drywall, low BTU value products, to be removed from the refuse material.

### BRIEF DESCRIPTION OF THE DRAWINGS

FIG. 1 is a top plan view of one embodiment of the present invention.

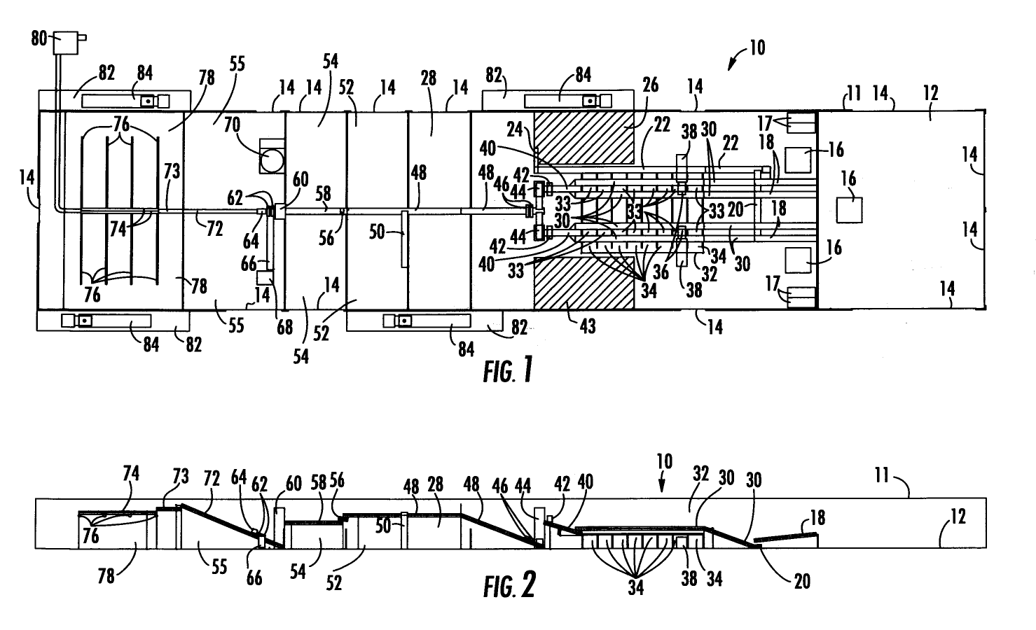

FIG. 2 is an elevation side view of one embodiment of the present invention.

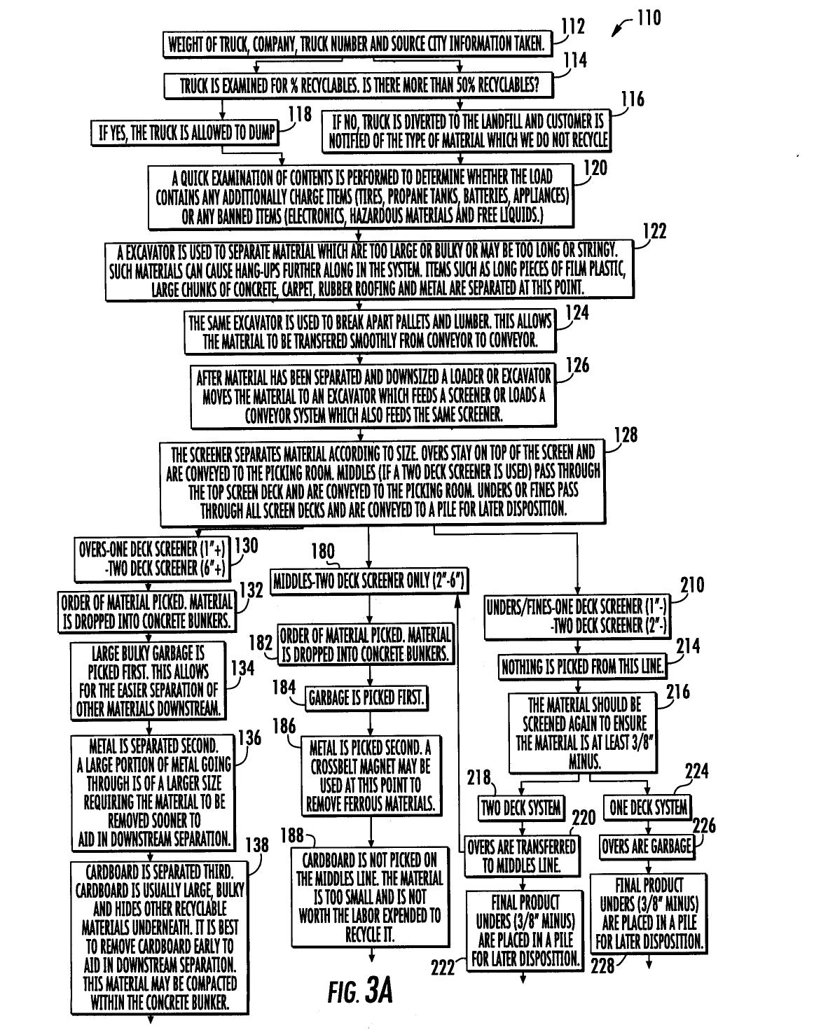

FIGS. 3A and 3B together show a flow chart of one embodiment of the method of the present invention.

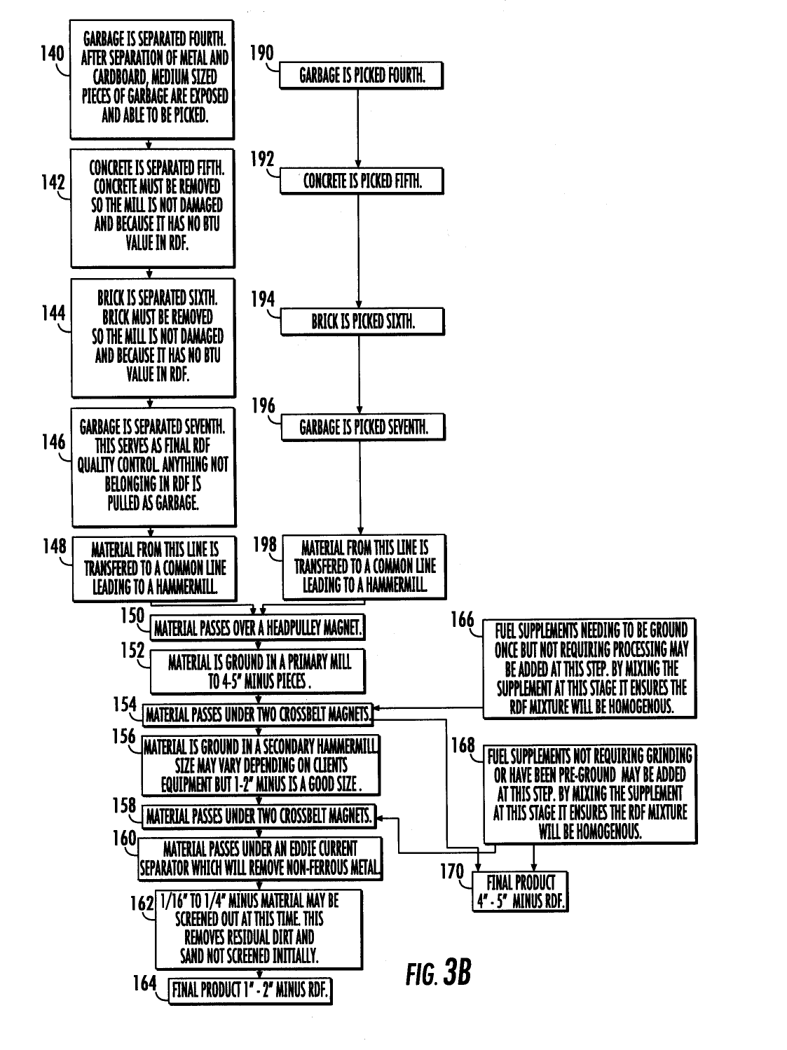

### DETAILED DESCRIPTION OF THE PREFERRED EMBODIMENT

Referring now to the figures, the present invention is a recycling system 10 contained within a building 11. Refuse haulers can bring refuse, such as construction and demolition waste refuse (i.e., scrap lumber, siding, shingles, bricks, etc.). The haulers dump the refuse material onto a gathering area or tipping floor 12. The haulers can travel into building 11 through the doorways 14 or can dump their load outside and then the refuse can be pushed inside with a bulldozer or similar-type device.

Loaders 16 can load the refuse material onto one of any number of screeners 18. The loader 16 can be a front loader, excavator, and similar type of a lifting and loading device. In addition, an automated loading device may be used. The loader 16 separates out large bulky non-recyclable items (mattresses, upholstered furniture, rubber, roofing, carpet, etc.) and large pieces of metal and concrete. These items are placed into roll-off box containers 17 to be either discarded or recycled in other ways. In addition, the loader crushes or down-sizes materials for loading materials onto the screener 18. Then, the loader 16 loads or feeds the construction demolition refuse material onto the screener 18, which then separates the materials into different sizes (overs and unders/fines).

The screener 18 separates the refuse materials that are put into it according to a screen size which is used within the screener 18. For example, if a 3 inch screen is used, the overs will be 3 inches and larger and the unders/fines will be 3 inches and smaller. Likewise, if a 5 inch screen is used, overs will be 5 inches and larger and unders/fines will be 5 inches and less. The screeners 18 can screen the refuse and transfer it forward to move the refuse along in the process.

A conveyor 20 receives the unders/fines from the screener 18 and conveys them to another conveyor 22 which, in turn, conveys the unders/fines to a vibratory conveyor 24. The vibratory conveyor 24 separates out the smallest particles such as those under ⅜ of an inch and below. The unders/fines which are larger than ⅜ of an inch are transferred to a garbage staging area 26 for later use or discarding. The unders/fines which are under ⅜ of an inch are generally dirt and gravel and are transferred to the dirt storage area 28. The dirt generated in this process can be sold to landfills to use for cover dirt for covering garbage in the landfill or used as non-structural backfill.

The overs, or refuse which is placed on the screener and not screened out, are conveyed by one or more conveyors 30 to a picking room 32. Preferably, the picking room 32 is placed on an upper level floor with holes 33 in the picking room floor and bunkers 34 below the picking room 32. The bunkers 34 are essentially holding areas so that non-fuel items placed in the bunkers 34 are stored for later recycling or disposal.

When the overs are conveyed through a picking room 32 they are sorted by sorters as they pass through the picking room 32 on the conveyor 30. Recyclables which are not dry, high BTU source of materials are picked out of the refuse traveling on the conveyor 30 and put into the bunkers 34 via a hole in the picking room floor 33. The items which are not dry, high BTU sources may be items such as concrete, brick, metal, etc. Recyclable refuse which is dry and has a high BTU value may or may not be picked from the conveyor 30, depending on the current value of the material such as cardboard, film, plastic, rigid plastic, paper, shingles, etc. If these items which are dry and have a high BTU value are picked from the conveyor 30, they may be compacted in a compactor 36 and stored in a compactor box 38 to reduce the volume of these items before shipping or otherwise recycling. Refuse materials which are on the conveyor 30 and have a high BTU value, but are difficult to shred, such as carpet, rubber roofing, etc. or do not have a high BTU value such as drywall, styrofoam, etc., are put into a garbage storage area 26. Additionally, problematic materials, such as treated wood, are also put into a garbage storage area 26.

Ferrous and non-ferrous metals should be picked from the conveyor 30. These items have a high recycling value, but no BTU value. These items can damage grinders. The metals are preferably separated into groups such as copper wire, copper pipe, cast iron, heavy iron, light iron, radiators, motors, brass, etc. These items can then individually be recycled. Concrete should be picked from the conveyor 30. Concrete has a low BTU value and increases ash value of the wood waste fuel. In addition, concrete will increase maintenance on grinding mills. Brick materials should be picked off the conveyor. Brick has a low BTU value and increases the ash value of the wood waste fuel and will additionally increase maintenance on grinding mills. Cardboard items should be picked from the conveyor 30 even if it is to be used as a fuel source. Cardboard is generally large and bulky and may hide recyclable materials underneath the cardboard on the conveyor 30. If the cardboard is not to be used in the wood waste fuel, it can be compacted in a compactor 36. If the cardboard is to be used in the wood waste fuel, it can be ground and added back to the fuel at some point downstream from the picking room 32. If other paper is to be picked from the conveyor 30, it can be compacted with a compactor 36. If the paper is to be used in the wood waste fuel, it can pass through the picking room 32 without being picked from the conveyor 30. Plastic films should be picked from the conveyor 30 even if they are to be used as a fuel source. Plastic films are generally large and bulky and may also hide recyclable materials underneath the plastic film. If the plastic film is not to be used in the wood waste fuel, it can be compacted in a compactor 36. If the film plastic is to be used in the wood waste fuel, it can be shredded and added back to the wood waste fuel at a point downstream from the picking room 32. If the plastic is not being recycled or added later to the wood waste fuel, it can be pulled and discarded as garbage. Carpet, rubber roofing, mattresses, upholstered furniture, etc. should be picked from the conveyor 30 even if they are to be used as a fuel source because they are large and bulky and may hide recyclable materials underneath them. If these items are not to be used in the wood waste fuel or recycled, they should be pulled as garbage. If these items are to be used in the wood waste fuel, they can be ground in a shredding area 55 and later added back to the wood waste fuel at a point downstream from the picking room 32. Hard plastics and shingles should be pulled from the conveyor 30 as garbage if they are not to be used in the wood waste fuel or recycled. If these items are to be used in the wood waste fuel, they can pass through the picking room 32 on the conveyor 30 without being picked. Problem items, such as treated lumber and railroad ties, should always be picked from the conveyor 30 and discarded as garbage, unless they can be recycled without grinding.

One or more conveyors 40 can take the recyclables which are to be turned into wood waste fuel, such as wood particles, and convey those items away from the picking room 32. Preferably, there is a head pulley magnet 42 or similar device placed at the end of conveyor 40 for pulling out metal which may have gotten through the picking room 32. The metal which is pulled off of the conveyor 40 is sent to a metal staging area 43 for recycling. The refuse materials left on the conveyor 40 is then sent to a primary grinder mill 44.

The primary grinder mill 44 grinds everything into smaller pieces. Generally, what will be sent to the primary grinder mill 44 will be a mix of dimensional lumber (2×4, 2×6, etc.), engineered wood (plywood, USB, etc.), and possibly cardboard, paper, film plastic, rigid plastic and shingles. The primary grinder mill 44 preferably grinds the refuse material into approximately 4-5 inch and smaller particles. After the ground refuse material passes from the primary grinder 44, it passes under one or more crossbelt magnets 46 on a conveyor 48. The crossbelt magnets 46 has a powerful enough magnetic force to pull ferrous metals which have been freed from the materials by the grinding process of the primary grinder mill 44. Fuel supplements requiring grinding, such as cardboard, plastics, etc., like those pulled from the picking room 32 can be stored in fuel supplement storage area 52 and added as a fuel supplement using one or more fuel supplement conveyors 50. Fuel supplements not requiring grinding can be stored in a fuel supplement storage area 54 until they are added to the fuel.

As shown in the figures, a conveyor 56 transports the ground refuse from the conveyor 48 to another conveyor 58. The conveyor 58 transports the ground material and the fuel supplements requiring grinding to a secondary grinder mill 60.

The secondary grinder mill 60 receives the 4-5 inch and smaller ground refuse materials. The secondary grinder mill 60 then grinds the refuse material to a final size of about 1-2 inches. The size of the material coming out of the secondary grinder mill 60 is determined by the requirements of the end user for the wood waste fuel.

Another set of crossbelt magnets 62 and an eddy current separator 64 pull ferrous and non-ferrous metals from the wood waste fuel passing out of the secondary grinder mill 60. The crossbelt magnets 62 have strong enough magnet field to pull ferrous metals which has been freed by the grinding process out of the wood waste fuel. The eddy current separator 64 separates non-ferrous metals away from the wood waste fuel. Thus, very little metal will remain in the wood waste fuel.

Additional fuel supplements which do not require grinding may be added to the wood waste fuel using a fuel supplement conveyor 66. The fuel supplements should be the same size or smaller than the final desired size of the wood waste fuel. Additionally, a carpet and tire grinder 68 can be located in the shredding area 55 and may be used to grind items such as carpet and tires to create fuel supplements for the wood waste fuel which can be added to the wood waste fuel using the fuel supplement conveyor 66. In addition, a wet fuel supplement system 70 may be used to spray wet fuel supplements such as waste oils, etc. on the dry wood waste fuel to increase the BTU value of the wood waste fuel.

Conveyor 72 transports the ground fuel to a vibratory conveyor 73. The vibratory conveyor 73 can be used for separating different sizes of the ground wood waste fuel. The wood waste fuel may be screened using the vibratory conveyor 73 to remove the fines or smaller particles. The screen size for the vibratory conveyor 73 may be about 1/16^{th} of an inch to ¼^{th} of an inch in size. However, the screen size for the vibratory conveyor 73 will ultimately be determined according to the wood waste fuel customer's specifications.

Once the wood waste fuel has been ground to the proper size and separated out as needed, an overhead U-trough auger 74 transports the wood waste fuel to one or more overhead distribution augers 76 for distributing the wood waste fuel to the wood waste fuel storage area 78. The wood waste fuel is stored in the wood waste fuel storage area until the fuel is sold.

The wood waste fuel may additionally be conveyed to one or more gasifiers 80. The gasifier 80 allows the wood waste fuel to be heated and converted into a burnable gas. The burnable gas can then be used as an energy source for any purpose. The gasifier 80 would produce a gas from the wood waste fuel which could be cleaned and sold as a medium grade gas and used as fuel to produce steam for a turbine to produce electricity. It is estimated that for each 100,000 tons of construction and demolition refuse received per year, enough wood waste fuel can be produced to supply a 5 megawatt generator which could potentially power approximately 5,000 homes.

For ease of loading the wood waste fuel or the recyclable metals, or the waste garbage, or etc., one or more sunken drive-throughs 82 are positioned along side the building 11 to allow semi-truck tractor trailers 84 to load the product and transport it away. Other types of loading set-ups can be used for hauling away the fuel, recyclable materials, or garbage.

The wood waste fuel product produced with this system is generally marketed as a coal replacement fuel. The wood waste fuel is produced from construction and demolition materials that generally have a moisture content of about 10% to 20% with a BTU value of about 6,000 to 8,000. The generated wood waste fuel is capable of replacing up to and including 100% of coal for coal using systems. Any size recycling system 10 and building 11 can be used; however, one embodiment will use a four conveyor line system with an estimate through put of approximately 160 to 200 tons per hour or approximately 40 to 50 tons per hour per conveyor line. Estimated capacities are based on different shifts and numbers of days of run are as follows:

1) 260 days/year, 1-8 hour shifts=332,800-416,000 tons/year;

2) 260 days/year, 2-8 hour shifts=665,600-832,000 tons/year;

3) 260 days/year, 3-6 hour shifts=748,800-936,000 tons/year;

4) 312 days/year, 2-12 hour shifts=1,198,080-1,497,600 tons/year.

This recycling system can allow the materials or refuse which is to be derived into fuel to pass through on conveying systems rather than pulling what is desired to be used as fuel. This allows for more material to pass through the system 10 and be turned into wood waste fuel. As a result, the present recycling system 10 is a much more efficient system and creates a larger output.

One method of operating the recycling system 10 of the present invention can be by the method of creating wood waste fuel 110. In this method, a truck containing refuse arrives at the wood waste fuel building 11 and an operator can check the weight of the truck, the company, the truck number and the source city information for the load 112. Then, the truck is examined for the percentage of recyclables on the truck. The operator determines whether there is more than 50% of recyclables on the truck 114. If the answer is no and the truck does not have more than 50% recyclables, the truck is diverted to a landfill and the customer is notified of the type of materials with which are not recycled into wood waste fuel 116. On the other hand, if the truck does have greater than 50% recyclables which can be recycled into wood waste fuel, the truck is allowed to dump its refuse 118.

A quick examination of the contents of the refuse is performed to determine whether the load contains any additional charge items such as tires, propane tanks, batteries, appliances, etc., or any banned items such as electronics, hazardous materials, and free floating liquids, etc. 120. An excavator is then used to separate the refuse materials which are two large and bulky or may be too long or stringy to easily manipulate. Such materials can cause hang-ups further along in the recycling system 10. Items such as long pieces of film plastic, large chunks of concrete, carpet, rubber roofing, metal, etc. are separated away from the refuse 122. The excavator is then used to break apart items such as pallets and lumber which allows the material to be transferred smoothly from conveyor to conveyor 124. After the materials have been separated and downsized, a loader or excavator moves the material to an excavator which feeds a screener or loads a conveyor system which also feeds a screener 126.

The screener separates materials according to size 128. Larger items or overs stay on top of the screen and are conveyed to a picking room. Medium items or middles, if a two-deck screener is used, pass through the top screen deck and are conveyed to a picking room. Smaller items or unders/fines pass through all screen decks and are conveyed to a pile for later disposition 128.

The larger items or overs are generally one inch or larger on a one deck screener or six inches or larger on a two-deck screener 130. The overs are then picked in the picking room in a specific order of material picked and the materials picked are dropped into concrete bunkers below the picking room 132. Large, bulky garbage is first picked allowing for easier separation of other materials downstream 134. Metal is next separated out and a large portion of metal going through is of a larger size so that it may be removed sooner to aid in downstream separation of the refuse items to be picked 136. Cardboard items are separated third because they are also usually large, bulky items and generally hide other recyclable materials underneath 138. It is best to remove cardboard early to aid in downstream separation and the cardboard material may be compacted within one or more concrete bunkers 138. Next, medium-size pieces of garbage which is exposed after the separation of metals and cardboards and the garbage is picked from the refuse 140. Concrete is separated next so that the grinding mills are not damaged and because they have little or no BTU value in the wood waste fuel 142. Then, the brick is pulled or separated so again the grinding mill is not damaged and because the brick has no BTU value for the wood waste fuel 144. Finally, garbage is separated from the refuse so that anything not belonging to the wood waste fuel is pulled as garbage from the refuse 146. Other order of picking is acceptable.

The refuse products which have not been picked from the refuse are transferred from one of several picking lines to a common line which leads to a primary grinder hammer mill 148. The refuse passes over a headpulley magnet 150. The refuse is ground in a primary mill to approximately 4-5 inches and smaller 152. Other sizes of ground refuse may be used. After exiting the primary grind mill, the material passes under two crossbelt magnets 154.

Then, the material is ground in a secondary hammer mill to approximately one to two inch sizes; however size may vary depending on customer's requirements 156. In some instances, a secondary mill is not necessary. Again, the secondarily ground wood waste fuel passes under two crossbelt magnets 158. In addition, the wood waste fuel passes under an eddy current separator which will remove non-ferrous metals from the wood waste fuel 160. The smallest particles which may be approximately 1/16^{th} of an inch to ¼^{th} of an inch or smaller may be screened out from the wood waste fuel so that residual dirt and sand are not generally in the final wood waste fuel 162. The final refuse derived product then ends up being approximately one to two inches in particle size wood waste fuel 164.

If supplements need to be added to the wood waste fuel and need to be ground once but do not require processing, they may be added by mixing the supplement to the wood waste fuel mixture at 154 where the material passes under two crossbelt magnets 166. On the other hand, fuel supplements not requiring grinding or which have been pre-ground may be added to the wood waste fuel by mixing the supplement after the fuel is ground a second time at 158 so that the wood waste fuel mixture will be a homogeneous mixture 168. As discussed above, if the material of the wood waste fuel is not to be ground a second time, the final wood waste fuel product or particle size may be approximately 4 to 5 inches and smaller 170. However any particle size product is acceptable.

Going back to the step where the screener separates the material according to size 128, the middles or medium-sized particles may be approximately 2 to 6 inches in size 180. The items picked from the refuse will be dropped into storage or concrete bunkers 182. The preferred sequence of picking from the refuse is as follows: Garbage is picked first 184, metal is picked second and may use a magnet to remove ferrous metals 186, cardboard is generally not picked on the middles because the cardboard material is too small and not worth the labor expended to recycle it separately 188, garbage is picked next 190, then, concrete is picked 192, brick is picked 194, and garbage is picked as a final quality control 196. From here, the medium-sized or middles will then be transferred to a common line leading to a hammer mill 198. Then, sequence continues on where the material passes over a headpulley magnet 150.

Again, returning to where the screener separates the materials according to size 128, the unders/fines or smallest particles can be approximately one inch on a single deck screener or approximately two inches and less on a two-deck screener 210. Nothing is to be picked from the unders/fine 214. The fines are then screened again to ensure that the particles are at least ⅜ of an inch and smaller 216. If the system is a two-deck system 218, the larger particles are transferred to the middles line 220 at 180. Otherwise, the final products are unders of ⅜^{th} of an inch and smaller which can be placed in a pile for later disposition 222. On the other hand, a single deck system 224 the larger particles are garbage 226 and the final product are unders under ⅜ of an inch and smaller which are placed in a pile for later disposition 228. Once again, any fuel particle size is acceptable with this invention.

The invention has been shown and described above with the preferred embodiments, and it is understood that many modifications, substitutions, and additions may be made which are within the intended spirit and scope of the invention. From the foregoing, it can be seen that the present invention accomplishes one or more of its stated objectives.

What is claimed is:

1. A system for creating a coal replacement wood waste fuel produced from waste refuse, the system comprising:
a tipping floor for gathering bulk refuse;
a loading device for separating the refuse into recyclable items and non-recyclable items and for loading the recyclable items which are to be screened;
a screener for separating the recyclable items into large recyclable items (overs) and small recyclable items (unders);
a conveyer for transporting the overs to be separated as fuel products and non-fuel products;
a picking area for separating the non-fuel products off the conveyer and away from the fuel products and discarding the non-fuel products;
a grinder for grinding the fuel products into a wood waste fuel; and
a magnet and/or eddy current separator for removing metals from the wood waste fuel.

2. The system of claim 1 further comprising a wet fuel system for adding liquids to the wood waste fuel which can increase a BTU value of the fuel.

3. The system of claim 1 further comprising second grinder for further grinding the fuel products into a wood waste fuel.

4. The system of claim 1 further comprising a distribution system for transporting the fuel from the grinder to a storage location.

5. The system of claim 1 further comprising a gasifier for consuming a portion of the fuel and outputting a burnable gas.

6. The system of claim 1 wherein the picking area has a plurality of picking stations where operators can pick non-fuel products from the conveyer.

7. The system of claim 1 wherein the bulk refuse has greater than 50% recyclable items.

8. The system of claim 1 housed in a building structure.

9. The system of claim 1 wherein the wood waste fuel has moisture content of about 10%-20% and a BTU value of about 6000-8000.

10. The system of claim 1 wherein recyclable non-fuel items are separated from the recyclable fuel items and stored for later recycling.

11. A method of creating a coal replacement wood waste fuel produced from waste refuse, the method comprising:
compiling bulk refuse;
separating the bulk refuse into recyclable refuse and non-recyclable refuse;
separating dirt out of the recyclable refuse and using the dirt for landfill cover material;
conveying the recyclable refuse to a picking area;
determining what conveyed recyclable refuse products are fuel products and what conveyed recyclable refuse products are non-fuel products;
picking the non-fuel products from the conveyed fuel products;
grinding the fuel products into a wood waste fuel; and
removing metals from the ground fuel products.

12. The method of claim 11 further comprising adding a burnable liquid to the wood waste fuel to increase BTU value of the fuel.

13. The method of claim 11 further comprising grinding the fuel products twice to produce a more uniformly ground wood waste fuel.

14. The method of claim 11 further comprising gasifying the wood waste fuel to produce a burnable gas.

15. The method of claim 11 wherein the step of removing metals removes both ferrous and non-ferrous metals from the ground fuel products.

16. The method of claim 11 wherein the waste refuse is building construction and demolition refuse.

17. A construction and demolition waste recycling system for converting high BTU value construction and demolition waste refuse into a coal replacement wood waste fuel having about a 6000-8000 BTU value, the system comprising;
an area for gathering bulk construction and demolition refuse materials;
a loading device for crushing oversized refuse materials and for moving the gathered refuse materials;
a vibrating screening system for receiving the refuse materials and separating dirt from the refuse materials;
a picking system for removing non-fuel products from the refuse materials;
a grinder for grinding remaining refuse materials into a wood waste fuel; and
a metal removing system for removing metal from the wood waste fuel.

18. The system of claim 17 wherein concrete, brick, and drywall are removed from the refuse materials.
